(19) United States
(12) Patent Application Publication
(10) Pub. No.: US 2008/0313016 A1
(43) Pub. Date: Dec. 18, 2008

(54) Method and System for Managing Media Content in a Network

(75) Inventor: Krishna Prasad Panje, Bangalore (IN)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 12/138,539

(22) Filed: Jun. 13, 2008

(30) Foreign Application Priority Data
Jun. 13, 2007 (IN) 1274/DEL/2007

(51) Int. Cl. G06Q 99/00; G06Q 30/00

(52) U.S. Cl. 705/10; 705/1

(57) ABSTRACT

A method and system for managing a plurality of media content in a network (100) is disclosed. The network includes a content server (104). The method includes associating (404) a skip count with a first media content. Further, the method includes providing (406) the first media content to a user equipment (108) in the network. The method also includes updating (408) the skip count when the first media content is skipped. Moreover, the method includes providing (410) a second media content to the user equipment when the skip count is equal to a predefined value.

### FIELD OF THE INVENTION

This invention relates in general to networks, and more specifically, to a method and system for managing media content in a network.

### BACKGROUND OF THE INVENTION

Networks are increasingly being used for information exchange in the present-day world. Examples of such networks include, but are not limited to, television networks, the Internet, and mobile networks. These networks have various uses, for example, they can be used to distribute media content. This media content can be watched by a user with the help of television and other electronic equipment, such as a video player. The advent of digital television and consumer products such as Digital Video Recorders (DVRs), Personal Video Recorders (PVRs), and time-shift recorders provide users with the flexibility of watching media content of their choice and avoid viewing undesired media content. Users can now watch, skip, jump or fast forward media content whenever they wish. They can also change channel if they do not want to watch media content shown on the channel. Skipping media content, for example an advertisement, can however result in the loss of a business opportunity as well as the advertisement fee, which affects everyone from the broadcaster to the end user, since a significant portion of the revenue is generated by advertisements.

Users can skip a particular advertisement if they are not interested in a particular product or they do not want to watch the same advertisement over and over again. The advertisement can also be skipped if it is not related to the users or they do not like a particular scene or the object of the advertisement.

There are known methods, providing monetary benefits, which can encourage users to watch advertisements. One such known method allows users to select a specific number of advertisements. In this method, users' bill for subscription of one or more channel is decreased, based on the number of advertisements watched. However, this method does not consider what users want to see. Therefore, there is a possibility that the advertisements shown within the specified limit are not liked by them and they skip them.

Another known method uses a plurality of pre-stored program clips to automatically replace an undesired advertisement by switching to another program clip. The television reverts to the previously viewed program after a pre-determined period of time. This method also does not take care of the viewing preferences of users.

Another known method dynamically inserts media content into the program breaks of one or more channels. This insertion is based on the current status of the program. Generally, for such dynamic insertion, the status of programs on a channel may be monitored periodically and/or continuously. However, this method also does not take into cognizance the viewing interests of users.

Therefore, there exists a need for a method and system for managing content in a network. The method should be able to consider the preferences of users while showing a media content.

### BRIEF DESCRIPTION OF THE FIGURES

The accompanying figures, where like reference numerals refer to identical or functionally similar elements throughout the separate views, and which, together with the detailed description below, are incorporated in and form part of the specification, serve to further illustrate various embodiments and explain various principles and advantages, all in accordance with the present invention.

FIG. 1 illustrates an exemplary network, where various embodiments of the present invention can be practiced;

FIG. 2 is a block diagram illustrating a content server, in accordance with one embodiment of the present invention;

FIG. 3 is a block diagram illustrating an user equipment, in accordance with one embodiment of the present invention;

FIG. 4 is a flowchart illustrating a method for managing media content in a network, in accordance with one embodiment of the present invention; and

FIG. 5 is a flowchart illustrating a method for managing media content in a network, in accordance with another embodiment of the present invention.

Skilled artisans will appreciate that elements in the figures are illustrated for simplicity and clarity and have not necessarily been drawn to scale. For example, the dimensions of some of the elements in the figures may be exaggerated, relative to other elements, to help in improving an understanding of the embodiments of the present invention.

### DETAILED DESCRIPTION

Before describing in detail the particular method and system for managing media content in a network, in accordance with various embodiments of the present invention, it should be observed that the present invention resides primarily in combinations of method steps related to the method and system for managing media content in the network. Accordingly, the apparatus components and method steps have been represented, where appropriate, by conventional symbols in the drawings, showing only those specific details that are pertinent for an understanding of the present invention, so as not to obscure the disclosure with details that will be readily apparent to those with ordinary skill in the art, having the benefit of the description herein.

In this document, the terms “comprises”, “comprising”, or any other variation thereof, are intended to cover a non-exclusive inclusion, such that a process, method, article or apparatus that comprises a list of elements does not include only those elements but may include other elements that are not expressly listed or inherent in such a process, method, article or apparatus. An element proceeded by “comprises . . . a” does not, without more constraints, preclude the existence of additional identical elements in the process, method, article or apparatus that comprises the element. The term “another”, as used in this document, is defined as at least a second or more. The terms “includes” and/or “having”, as used herein, are defined as comprising

For one embodiment, the present invention provides a method for managing a plurality of media content in a network. The network includes a content server. The method at the content server includes associating a skip count with a first media content. Further, the method includes providing the first media content to a user equipment in the network. The method also includes updating the skip count when the first media content is skipped. Moreover, the method includes providing a second media content to the user equipment when the skip count is equal to a predefined value.

For another embodiment, the present invention provides a content server for managing a plurality of media content in a network. The content server includes a receiving module that is configured to receive the plurality of media content. Further, the content server includes a processing module that is configured to associate a skip count with a first media content of the plurality of media content. The content server also includes a transmitting module that is configured to transmit the first media content to user equipment. Furthermore, the transmitting module is also configured to transmit a second media content to the user equipment when the skip count is equal to a predefined value.

For yet another embodiment, the present invention provides a user equipment for managing a plurality of media content in a network. The user equipment includes a first receiving module that is configured to receive a first media content. The first media content is associated with a skip count. Further, the user equipment includes a processing module that is configured to update the skip count associated with the first media content. The user equipment also includes a second receiving module that is configured to receive a second media content when the skip count is equal to a predefined value.

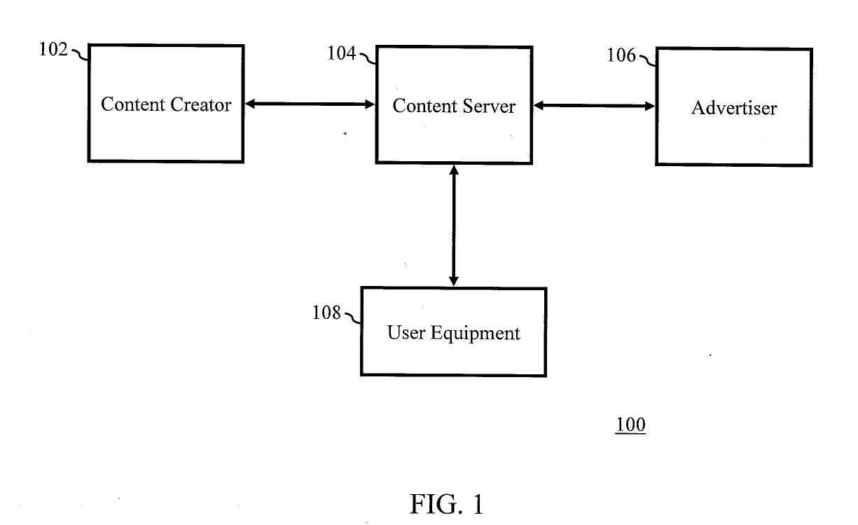

FIG. 1 illustrates an exemplary network 100, where various embodiments of the present invention can be practiced. For purpose of this description, the network 100 is shown to include a content creator 102, a content server 104, an advertiser 106, and a user equipment 108. Examples of the network 100 include, but are not limited to, a television network, the Internet and a mobile network. The content creator 102 creates a plurality of media content that can be managed in the network 100. Examples of the content creator 102 can be a satellite channel, a movie studio, an advertisement creator, and a mobile service provider. Examples of the media content can include a commercial message, an advertisement, trade-related information, current program information, future program information, a display logo, a subtitle, audio information, a channel logo, a ticker, and a flash display.

The content creator 102 associates a skip count with the plurality of media content and provides the skip count to the content server 104. In one embodiment, the content server 104 can associate a skip count with the plurality of media content. The associated skip count can determine the number of times a media content can be skipped by the user. Each time the media content is skipped by the user, the skip count is updated by either continuously increasing or decreasing the value of the skip count every time the media content is skipped by the user. Examples of skipping the media content can include changing the channel on which the media content is shown or fast forwarding the media content. For example, a first media content, showing an advertisement related to computers, can be associated with a skip count of ‘five’. In this example, the first media content showing the advertisement related to computers can be skipped five times if the skip count is decreased by one every time the media content is skipped. The content creator 102 sends the plurality of media content to the content server 104. Examples of the content server 104 include, but are not limited to, a satellite station, a broadcast station, a base station, a head-end device at the end of cable network, and a radio station. The content server 104 can associate one or more attributes with the plurality of media content. In one embodiment, the content creator 102 can associate one or more attributes with the plurality of media content and provides the one or more attributes to the content server 104. These one or more attributes can be used to identify each media content of the plurality of media content. For example, a first media content, related to cars, can be associated with the attribute ‘car’. In another example, the attribute can be a brand name such as ‘Company A’ and ‘Company B’. In one embodiment, the advertiser 106 creates an advertisement and sends it to the content creator 102. The content creator 102 inserts the advertisement in a media content such as a weekly health program and sends it to the content server 104. The content server 104 provides the media content to the user equipment 108. Examples of the user equipment can include a Television (TV), a computer, a mobile, a radio, and a set-top box.

The media content can be displayed on the user equipment 108. Further, users can skip the media content if they do not want to watch it. Each time a user skips the media content shown on the user equipment, the skip count is updated. For example, every time the first media content showing an advertisement related to computers is skipped, the skip count of ‘five’ can be decreased by one. Further, the content server 104 provides a second media content to the user equipment 108 when the skip count is equal to a predefined value. For example, the first media content showing an advertisement related to computers and associated with the skip count of ‘five’ can be assigned a predefined threshold value of ‘zero’. Therefore, when the first media content is skipped five times, the content server 104 provides a second media content to the user equipment 108. In one embodiment, the second media content is provided, based on the preferences received from the user equipment 108.

Though the various embodiments are explained in conjunction with a content server, a content creator and an advertiser, it will be apparent to a person ordinarily skilled in the art that the various functionalities associated with the content server, the content creator and the advertiser can be implemented by using a single server.

For the purpose of this description, updating the skip count is taken as decreasing the value of skip count by one. Further, the predefined value is taken as zero. However, it will be apparent to a person ordinarily skilled in the art that there can be various ways of updating the skip count, and similarly, a different predefined value can be associated with each media content of the plurality of media content.

In accordance with another example, consider an advertisement for a shampoo that is especially made for dry hair. The content server 104 associates a skip count of ‘four’ with the advertisement. Users with oily hair will not be interested in watching the advertisement of a shampoo for dry hair. Therefore, such users can skip the advertisement. The skip count is decreased by ‘one’ every time the advertisement is skipped. When a user has skipped the advertisement four times, the skip count becomes zero. Thereafter, the user is prompted to give his preference for one or more attributes associated with the media content. For example, the user is asked to indicate his/her preference for the attribute ‘hair type’. The content server 104 provides a second advertisement, based on the preference of the user. In one example, the user can select ‘oily’ as his/her preference for the attribute ‘hair type’, and the second media content can be an advertisement of a shampoo for oily hair. The second advertisement can be from the same advertiser that makes the shampoo for dry hair. This gives the advertiser a chance to provide different and relevant products to the user. An advertisement from the same advertiser also makes the user aware of different products of the advertiser.

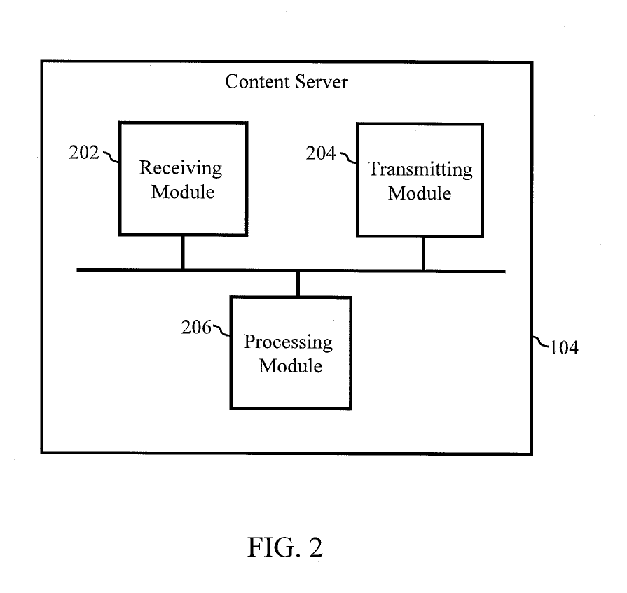

FIG. 2 is a block diagram illustrating the content server 104, in accordance with one embodiment of the present invention. For the purpose of this description, the content server 104 is shown to include a receiving module 202, a transmitting module 204 and a processing module 206. The receiving module 202 receives a plurality of media content that are being managed in the network 100. The receiving module 202 can also receive one or more preferences from the user equipment 108 and sends the plurality of media content to the processing module 206.

The processing module 206 associates a skip count with a first media content of the plurality of media content. The processing module 206 can also associate one or more attributes with each media content of the plurality of media content. The one or more attributes can be used to identify each media content of the plurality of media content. For example, attributes associated with an advertisement for a shampoo can be ‘type of hair’ and ‘brand’.

In an example when a media content is in MPEG-2 format, the attributes can be multiplexed with content metadata. A media content in MPEG-4 and MPEG-7 format use objects to represent aural, visual or audiovisual content. The attributes can be made a part of object attributes for media content in MPEG-4 and MPEG-7 format. Objects for MPEG-4 can be described with the help of MPEG syntax definition language. Multimedia description schemes can also be used to describe and annotate media content. These schemes use XML to facilitate the searching, indexing, filtering, and accessing of the media content. In addition to the languages described above, scene description language can be used to describe media content by using simple ASCII codes. In one or more languages described above, digital asset management techniques can be used to facilitate indexing, storing, searching and retrieving media content through metadata tags.

In one embodiment, the processing module 206 is capable of associating an identification tag with each media content of the plurality of media content. The identification tag provides an identity to the each media content. For example, the company ‘XYZ’ can create several advertisements. Let the identification tag associated with XYZ be 123. If XYZ creates three advertisements, these three advertisements can be identified as 1231, 1232 and 1233. Further, the processing module 206 can associate a skip count with each advertisement of the three advertisements. For example, the processing module 206 can associate a ‘seven’ skip count to 1231, a ‘two’ skip count to 1232, and a ‘three’ skip count to 1233. Thereafter, the processing module 206 provides the plurality of media content to the transmitting module 204, which transmits a first media content to a user equipment. Further, the transmitting module transmits a second media content to the user equipment when the skip count is equal to the predefined value. For example, the transmitting module 204 transmits a first media content, an advertisement, with the identification tag 1232. When the user skips this advertisement twice, the skip count equals the predefined value ‘zero’. The transmitting module 204 can transmit a second media content, an advertisement, with the identification tag 1233.

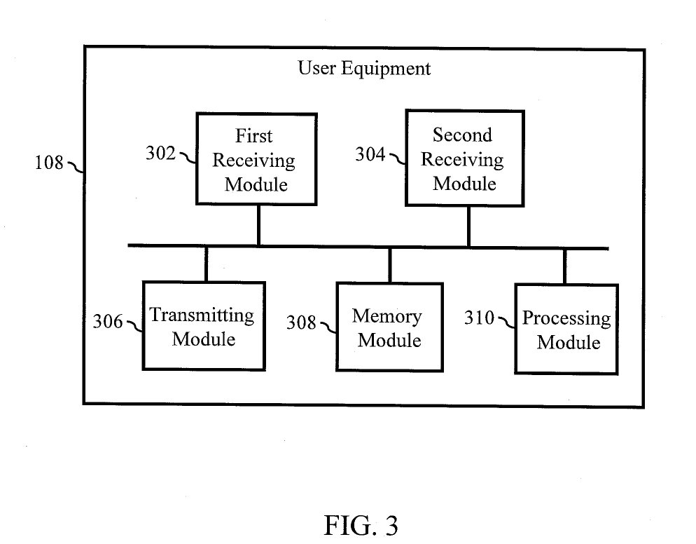

FIG. 3 is a block diagram illustrating the user equipment, in accordance with an embodiment of the present invention. For the purpose of this description, the user equipment 108 is shown to include a first receiving module 302 and a second receiving module 304. The first receiving module 302 is configured to receive a first media content and the skip count associated with the advertisement. For example, the advertisement with the identification tag 1232 and skip count of ‘two’ can be received by the first receiving module 302. A processing module 310 in the user equipment 108 updates the skip count associated with the first media content whenever the media content is skipped. Further, the second receiving module 304 receives a second media content when the skip count of the first media content is equal to a predefined value. For example, the second receiving module 304 receives a second advertisement with identification tag 1233 and a skip count of ‘three’ when the advertisement with identification tag 1232 is skipped twice.

Though the various embodiments will be explained in conjunction with a first receiving module and a second receiving module, it will be apparent to a person ordinarily skilled in the art that the various functionalities associated with the first receiving module and the second receiving module can be integrated and implemented by using a single receiving module.

In one embodiment, the user equipment 108 also includes a transmitting module 306, which is configured to transmit one or more preferences of a user. These one or more preferences correspond to one or more attributes of a media content. When the skip count of the first media content equals a predefined value, the user can be asked to provide one or more preferences corresponding to one or more attributes. The content server 104 transmits a second media content, based on the one or more preferences received for one or more attributes. For example, the user may be asked to select a car model after the skip count corresponding to a media content, an advertisement for a car, becomes equal to the predefined value.

In one embodiment, the user equipment 108 also includes a memory module 308, which is configured to store at least one of the first media content and the second media content. For example, different car advertisements corresponding to ‘model A’, ‘model B’ and ‘model C’ of a car can be stored in the memory module. The processing module 310 is configured to select the second media content, based on the one or more preferences of the user. For example, the processing module 310 provides an advertisement of ‘model B’, a sports car, based on users' preference to see a sports car. The processing module 310 can also be configured to select the second media content, based on an identification tag. For example, the advertisement for ‘model A’ is associated with an identification tag 1231, the advertisement for ‘model B’ with 1232, and the advertisement for ‘model C’ with 1233. If the user skips the advertisement with identification tag 1232 for a specified number of times, the processing module 310 selects and provides another advertisement with identification tag 1233.

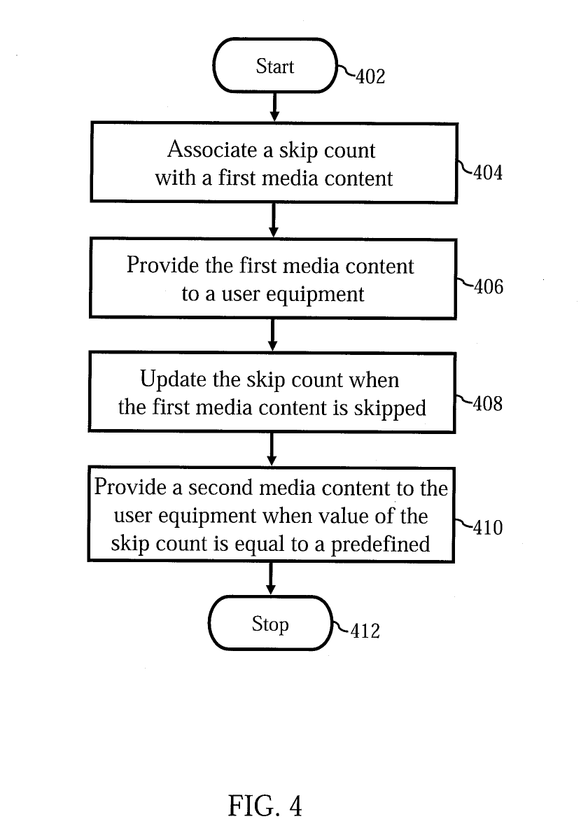

FIG. 4 is a flowchart illustrating a method for managing media content in a network, in accordance with an embodiment of the present invention. The method for managing a plurality of media content at the content server 104 is initiated at step 402. At step 404, the content server 104 associates a skip count with a first media content. The skip count determines the number of times the first media content can be skipped. For example, the skip count associated with the first media content can be ‘five’. At step 406, the first media content is provided to a user equipment. At step 408, the skip count is updated whenever the first media content is skipped. For example, when the first media content with a skip count of ‘five’ is skipped, the skip count can be updated to ‘four’.

At step 410, a second media content is provided to the user equipment when the skip count of the first media content is equal to a predefined value. For example, the skip count associated with the first media content can be ‘five’ and the predefined value can be ‘zero’. When the first media content is skipped five times, the predefined value reaches ‘zero’. Thereafter, a second media content is provided to the user equipment 108 in place of the first media content. The method for managing a plurality of media content in a network is terminated at step 412.

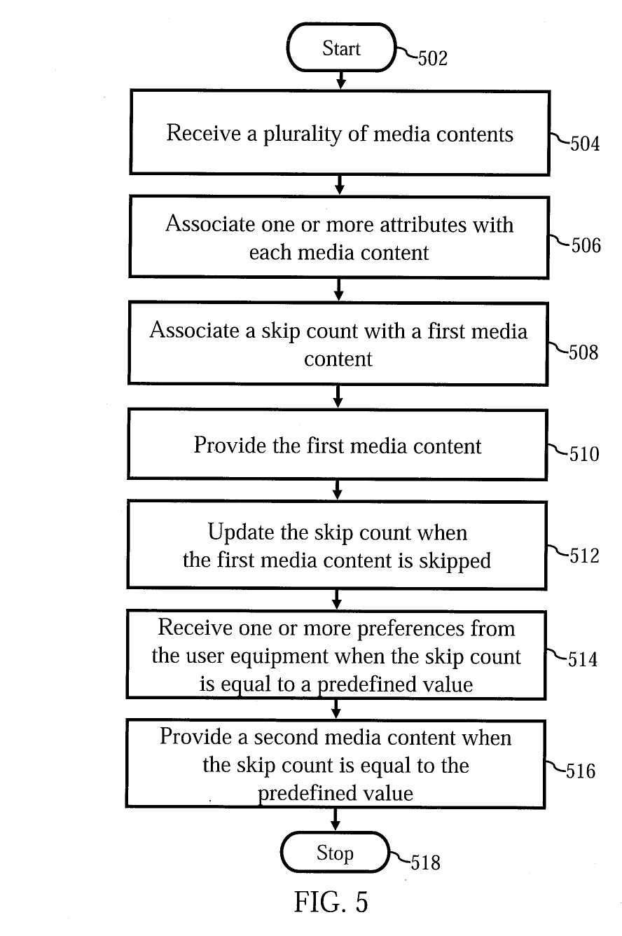

FIG. 5 is a flowchart illustrating a method for managing media content in a network, in accordance with an embodiment of the present invention. The method for managing a plurality of media content at the content server 104 is initiated at step 502. At step 504, the content server 104 receives a plurality of media content, which can be received from the content creator 102. In one embodiment, the advertiser 106 provides advertisements to the content creator 102. Thereafter, the content creator 102 can include the advertisements in the plurality of media content. For example, an advertisement for a washing machine can be included in a family program shown on television. At step 506, one or more attributes are associated with each media content of the plurality of media content. The processing module 206 is configured to associate one or more attributes with a media content. These one or more attributes are used to identify each media content of the plurality of media content. For example, the media content related to perfumes can be associated with the attribute ‘perfume’.

At step 508, a skip count is associated with a first media content of the plurality of content. The skip count can specify the number of times the first media content can be skipped. In one embodiment, the skip count can be related to the number of media content available to a company. For example, if a company A has 15 advertisements and a company B has five advertisements, the skip count associated with the advertisements of company A can be ‘five’ and the skip count associated with the advertisements of company B be can be ‘30’.

At step 510, the content server 104 provides the first media content to the user equipment 108, which displays the first media content to the user. At step 512, the skip count is updated when the first media content is skipped by the user. For example, the skip count can be decreased by one each time the user skips the first media content. For instance, an advertisement for health equipment can be associated with a skip count of ‘12’. The skip count is decreased by one whenever the user skips this advertisement.

At step 514, the user equipment receives one or more preferences from the user equipment when the skip count is equal to a predefined value. The one or more preferences correspond to one or more attributes of the first media content, which are displayed to the user when the skip count is equal to the predefined value. The one or more attributes are used to provide alternatives to users, so that they can indicate their preferences. For example, an advertisement for health equipment can have a skip count of ‘12’ and a predefined value of ‘zero’. The advertisement can have an ‘area of application’ and ‘age’ as two attributes. Further, there can be alternatives such as ‘shoulders’, ‘chest’ and ‘abdomen’, corresponding to the ‘area of application’ attribute. Similarly, there can be alternatives such as ‘10-20’, ‘20-25’, ‘25-40’ and ‘40 above’, corresponding to the ‘age’ attribute. After the advertisement has been skipped 12 times, i.e., when the skip count is equal to ‘zero’, the attributes are shown to the users. The users can indicate their preference, corresponding to each alternative. In one example, the user chooses ‘abdomen’ and ‘20-25’ as two attributes. These preferences are transmitted by the transmitting module 306 and are received by the receiving module 202 in the content server 104.

At step 516, the content server 104 provides a second media content to the user equipment 108 when the skip count is equal to the predefined value. The predefined value can be controlled by the content server 104. In one embodiment, the second media content is based on the one or more preferences received from the user equipment. In the example described at step 514, a second media content is provided to the user equipment, displaying health equipment for the abdomen area, which is suited for the age group of 20-25 years. In another embodiment, the second media content is randomly provided to the user equipment 108.

In one embodiment, the one or more preferences received from the user equipment 108 are sent to the content creator 102. The content creator 102 sends the second media content to the content server 104, based on the one or more preferences. The content server 104 then provides the second media content to the user equipment 108.

The description mentioned above can be understood with the following example. Consider that a channel ‘Alpha’ provides a 15-minute program, a first media content, on ‘Hindu mythology’ on every weekday at 5 p.m. local time. A user, who is a rock singer, may not be interested in watching this program, and may be more interested in watching a program that is related to ‘Evolution of Rock Music’. Since the user is not interested in watching the first media content, he may skip it by changing the channel. The channel Alpha can associate a skip count of ‘two’ with the first media content. Therefore, when the user skips the first media content a second time, one or more attributes related to the 15-minute program are shown to him/her. For example, the attributes associated with the 15-minute program can be ‘genre’ and ‘time period’. Further, one or more alternatives can be provided for each attribute of the one or more attributes. The alternatives corresponding to the ‘genre’ attribute can be ‘spiritual’, ‘rock’, ‘exercise’ and ‘sports’. The alternatives corresponding to the ‘time period’ attribute can be ‘history’, ‘modern’, ‘last year’ and ‘recent development’. The user can select the ‘rock’ alternative that corresponds to the ‘genre’ attribute, and ‘history’ alternative corresponds to the ‘time period’ attribute. Thereafter, at 5 p.m. local time, the Alpha channel can provide the second media content, in accordance with the one or more alternatives selected by the user. In one embodiment, one or more media contents can be stored on the user equipment and selected, based on the one or more preferences of the user. For example, the users' equipment with digital video recorder can download the media content with ‘rock’ and ‘history’ attributes and can show this media content to the user at 5 p.m. local time.

Various embodiments, as described above, provide a method and content server for managing a plurality of media content in a network. The present invention provides the content creator with a better opportunity for being heard. Further, the user also gets more options for the media content to be viewed. Users can also receive the media content, based on their preferences, which correspond to one or more attributes of the media content.

In the foregoing specification, the invention and its benefits and advantages have been described with reference to specific embodiments. However, one with ordinary skill in the art would appreciate that various modifications and changes can be made, without departing from the scope of the present invention, as set forth in the following claims. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage or solution to occur or become more pronounced are not to be construed as critical, required or essential features or elements of any or all the claims. The invention is defined solely by the appended claims, including any amendments made during the pendency of this application and all equivalents of those claims, as issued.

What is claimed is:

1. A method for managing a plurality of media content in a network, the network comprising a content server, the method at the content server comprising:
associating a skip count with a first media content;
providing the first media content to a user equipment in the network;
updating the skip count when the first media content is skipped; and
providing a second media content to the user equipment when the skip count is equal to a predefined value.

2. The method as recited in claim 1 further comprising receiving the plurality of media content from a content creator in the network.

3. The method as recited in claim 1 further comprising:
associating one or more attributes with each media content of the plurality of media content, wherein the one or more attributes are used to identify the each media content of the plurality of media content;
providing one or more attributes associated with the first media content to the user equipment when the skip count is equal to the predefined value; and
receiving one or more preferences from the user equipment based on the one or more attributes, wherein the second media content is provided to the user equipment based on the one or more preferences received from the user equipment.

4. The method as recited in claim 3 further comprising:
sending the one or more preferences received from the user equipment to a content creator in the network; and
receiving the second media content from the content creator based on the one or more preferences from the user equipment.

5. The method as recited in claim 1 further comprising associating an identification tag with each media content of the plurality of media content in the network, wherein the identification tag provides an identity to the each media content.

6. A content server comprising:
a receiving module configured to receive a plurality of media content;
a processing module configured to associate a skip count with a first media content of the plurality of media content; and
a transmitting module configured to:
transmit the first media content to a user equipment; and
transmit a second media content to the user equipment when the skip count is equal to a predefined value.

7. The content server as recited in claim 6, wherein the processing module is further configured to associate one or more attributes with each media content of the plurality of media content, wherein the one or more attributes are used to identify the each media content of the plurality of media content.

8. The content server as recited in claim 7, wherein the receiving module is further configured to receive one or more preferences from the user equipment based on the one or more attributes.

9. The content server as recited in claim 6, wherein the processing module is further configured to associate an identification tag to each media content of the plurality of media content, wherein the identification tag provides an identity to the each media content.

10. The content server as recited in claim 6, wherein the content server is selected from the group consisting of satellite station, a broadcast station, a base station, and a radio station.

11. A user equipment comprising:
a first receiving module configured to receive a first media content, wherein the first media content is associated with a skip count;
a processing module configured to update the skip count associated with the first media content; and
a second receiving module configured to receive a second media content when the skip count is equal to a predefined value.

12. The user equipment as recited in claim 11 further comprising a memory module configured to store at least one of the first media content and the second media content.

13. The user equipment as recited in claim 11, wherein the processing module is further configured to select the second media content based on an identification tag.

14. The user equipment as recited in claim 11, wherein the processing module is further configured to select the second media content based on one or more preferences of a user when the skip count is equal to the predefined value.

15. The user equipment as recited in claim 11 further comprising a transmitting module, wherein the transmitting module is configured to transmit one or more preferences of a user, and wherein the one or more preferences correspond to one or more attributes of the first media content.

16. The user equipment as recited in claim 11, wherein the first receiving module and the second receiving module are integrated.
